(19) United States
(12) Patent Application Publication
(10) Pub. No.: US 2026/0184632 A1
(43) Pub. Date: Jul. 2, 2026

(54) METHOD OF MANUFACTURING CEMENT ADDITIVE AND METHOD OF MANUFACTURING CEMENT COMPOSITION

(71) Applicant: TAIHEIYO CEMENT CORPORATION, Tokyo (JP)

(72) Inventors: Reishi OZAKI, Tokyo (JP); Ryuichiroh KUGA, Tokyo (JP); Yoko HIRANO, Tokyo (JP); Hikotsugu HYODO, Tokyo (JP)

(73) Assignee: TAIHEIYO CEMENT CORPORATION, Tokyo (JP)

(21) Appl. No.: 19/130,464

(22) PCT Filed: Nov. 16, 2023
(86) PCT No.: PCT/JP2023/041314

§ 371 Date: May 15, 2025

(30) Foreign Application Priority Data
Nov. 17, 2022 (JP) 2022-184188

(51) Int. Cl. C04B 14/04; C04B 14/28; C04B 18/08; C04B 20/04; C04B 28/04

(52) U.S. Cl. CPC C04B 14/047; C04B 14/28; C04B 18/08; C04B 20/04; C04B 28/04

(57) ABSTRACT

According to an aspect, provided is a method of manufacturing a cement additive, that includes removing a fine powder component by classifying a ground product of natural zeolite, wherein the cement additive at least contains at least a portion of the ground product after the removal of the fine powder component.

### CROSS-REFERENCE TO RELATED APPLICATIONS

This application claims priority to Japanese Patent Application No. 2022-184188 filed on Nov. 17, 2022, which is expressly incorporated herein by reference in its entirety.

### TECHNICAL FIELD

The present invention relates to a method of manufacturing a cement additive and to a method of manufacturing a cement composition.

### BACKGROUND ART

The preparation of a cement composition by mixing zeolite with a cement component is disclosed in PTL 1 and PTL 2, each of which is expressly incorporated herein by reference in its entirety.
PTL1: Japanese Patent Application Publication No. 2000-143317
PTL2: Japanese Patent Application Publication No. 2020-128315

### SUMMARY OF INVENTION

Fly ash has been widely used as a cement additive such as a cement admixture or concrete admixture. However, fly ash is a coal ash generated from, for example, fine coal combustion boilers in coal-fired power plants. In order to realize a decarbonized society, there has been desired in recent years to cut back on coal-fired power plants, which emit large amounts of CO₂, and the supply of fly ash is thus expected to be depleted in the future. The present inventors have therefore investigated the use of natural zeolite, which is a type of natural pozzolan, as a cement additive to replace fly ash. The results of these investigations have made it clear that a cement composition to which natural zeolite has been added exhibits a lower fluidity than a fly ash-containing cement composition.

In view of these circumstances, an objective of one aspect of the present invention is to suppress the fluidity reduction exhibited by natural zeolite-containing cement compositions.

A natural zeolite ground product is generally used in the preparation of natural zeolite-containing cement compositions. As a result of extensive and intensive investigations, the present inventors have newly discovered that the fluidity reduction exhibited by natural zeolite-containing cement compositions can be suppressed by mixing a natural zeolite ground product, after the removal therefrom of a fine powder component, with other components for manufacturing a cement composition.

As a result of extensive and intensive investigations, the present inventors have also newly discovered that the fluidity reduction exhibited by natural zeolite-containing cement compositions can be suppressed by mixing a natural zeolite heated ground product—prepared by heating a natural zeolite during at least one of any of prior to grinding, during grinding, and after grinding of the natural zeolite—with other components for manufacturing a cement composition.

Thus, an aspect of the present invention is as follows.

[1] A method of manufacturing a cement additive (also referred to in the following as “cement additive manufacturing method 1”), that includes:
removing a fine powder component by classifying a ground product of natural zeolite, wherein
the cement additive at least contains at least a portion of the ground product after the removal of the fine powder component.

[2] The manufacturing method according to [1], that further includes heating the ground product of natural zeolite at one or more of any of prior to the classification, during the classification, and after the classification.

[3] The manufacturing method according to [2], wherein the heating temperature during the heating is 200° C. or higher and 900° C. or lower.

[4] The cement additive manufacturing method according to any of [1] to [3], wherein the cement additive further contains fly ash and/or limestone powder.

[5] A method of manufacturing a cement additive (also referred to in the following as “cement additive manufacturing method 2”), that includes:
preparing a heated ground product of natural zeolite by heating a natural zeolite at one or more of any of prior to natural zeolite grinding, during natural zeolite grinding, and after natural zeolite grinding, wherein
the cement additive at least contains at least a portion of the heated ground product.

[6] The manufacturing method according to [5], wherein the heating temperature during the heating is 200° C. or higher and 900° C. or lower.

[7] The cement additive manufacturing method according to [5] or [6], wherein the cement additive further contains fly ash and/or limestone powder.

[8] A method of manufacturing a cement composition, that includes:
manufacturing a cement additive by the cement additive manufacturing method according to any of [1] to [7]; and
mixing the manufactured cement additive with at least a ground cement clinker.

According to an aspect of the present invention, a natural zeolite-containing cement composition that exhibits a suppression of fluidity reduction can be manufactured.

### BRIEF DESCRIPTION OF DRAWINGS

FIG. 1 is a graph that shows the particle size distribution of natural zeolite ground product Z1.

FIG. 2 is a graph that shows the rate of change of the particle size distribution shown in FIG. 1.

FIG. 3 is a graph that shows the particle size distribution for three classification fractions (coarse powder component Zc, middle powder component Zm, and fine powder component Zf) yielded by classification of natural zeolite ground product Z1.

### DESCRIPTION OF EMBODIMENTS

### [Methods of Manufacturing a Cement Additive]

An aspect of the present invention relates to cement additive manufacturing method 1. Cement additive manufacturing method 1 includes removing a fine powder component by classifying a ground product of natural zeolite (also referred to hereafter simply as the “ground product”), wherein the cement additive at least contains at least a portion of the ground product after the removal of the fine powder component.

In addition, an aspect of the present invention relates to cement additive manufacturing method 2. Cement additive manufacturing method 2 includes preparing a heated ground product of natural zeolite by heating a natural zeolite in at least one of any of prior to natural zeolite grinding, during natural zeolite grinding, and after natural zeolite grinding, wherein the cement additive at least contains at least a portion of the heated ground product.

In the following, cement additive manufacturing method 1 and cement additive manufacturing method 2 are also collectively referred to as “the cement additive manufacturing method” or simply “the manufacturing method”. Unless specifically indicated otherwise, descriptions directed to cement additive manufacturing method 1 also apply to cement additive manufacturing method 2 and descriptions directed to cement additive manufacturing method 2 also apply to cement additive manufacturing method 1.

The cement additive manufacturing method are described in greater detail in the following.

### <Cement Additive>

In the present invention and the present description, “cement additive” includes cement admixtures and concrete admixtures. When used as a cement admixture, the cement additive can, for example, be introduced into a mixer of mixed cement. When used as a concrete admixture, on the other hand, concrete (mortar, concrete, or cement paste) can be manufactured by mixing the cement additive into the cement. The cement additive may also be mixed with cement and other materials, for example, water and the like, followed by curing.

The cement additive, for example, can be used to manufacture a cement composition, as described above. When a cement additive manufactured by the above manufacturing method is used as such a cement additive, the fluidity reduction of the cement composition can be reduced in comparison to that for simply grinding and using natural zeolite.

With regard to cement additive manufacturing method 1, it is a new finding, not heretofore known, that the fine powder component in a natural zeolite ground product causes a reduction in the fluidity of cement compositions. Natural zeolite contains multiple types of minerals, and these minerals have different hardnesses. Harder minerals are more resistant to microparticulation by grinding, while softer minerals are susceptible to microparticulation by grinding. The present inventors therefore assume that differences in mineral composition are generated among the multiple classification fractions separated into different particle sizes by classification. With regard to this point, the present inventors assume that minerals that are readily microparticulated by grinding cause a reduction in the fluidity of concrete compositions. As a consequence, the present inventors assume that classifying a natural zeolite ground product, and separating and removing the fine powder component from the other classification fractions contributes to suppressing the fluidity reduction of concrete compositions. However, the preceding is only an assumption and does not limit the present invention.

With regard to cement additive manufacturing method 2, it is a new finding, not heretofore known, that the fluidity reduction of cement compositions containing natural zeolite as a cement additive can also be suppressed by heating the natural zeolite at one or more of any of prior to natural zeolite grinding, during natural zeolite grinding, and after natural zeolite grinding.

### <Natural Zeolite>

The natural zeolite used in the cement additive manufacturing method is a natural zeolite, and is not otherwise particularly limited. The natural zeolite may contain one or more types of aluminosilicate minerals. The aluminosilicate mineral may be a salt containing a freely selected cation, for example, a calcium salt. For example, the natural zeolite may contain one or both of clinoptilolite and mordenite, and may additionally contain one or more types of other silicate minerals. The other silicate mineral can be exemplified by anorthite, cristobalite, quartz, and biotite. In addition, the aluminosilicates that make up natural zeolites are natural products and exhibit a variety of crystallinities and as a consequence can also include low-crystallinity amorphous aluminosilicates that are identified as amorphous by X-ray diffraction (XRD) analysis. In an embodiment, an example of natural zeolite is natural zeolite in which either clinoptilolite or mordenite exhibits the highest content (mass basis) among the various components identified as aluminosilicate minerals by XRD analysis.

However, the above example is only an example and does not limit the present invention. The zeolite purity in the natural zeolite, as determined by XRD analysis, can be, for example, 50.0% or higher, or 55.0% or higher, or 60.0% or higher, and can be, for example, 90.0% or lower, or 80.0% or lower, or 70.0% or lower; however, there is no limitation to the preceding. The “%” used for zeolite purity is on a mass basis.

<Removal of Fine Powder Component from Natural Zeolite Ground Product>

### (Natural Zeolite Ground Product)

The “natural zeolite ground product” in the present invention and present description includes natural zeolite ground product that has been heated prior to grinding and/or during grinding as well as natural zeolite ground product on which such heating has not been carried out. The details of the heating are described below.

The “natural zeolite heated ground product” in the present invention and present description denotes a natural zeolite heated ground product prepared by heating a natural zeolite in any one or more of prior to grinding of the natural zeolite, during grinding of the natural zeolite, and after grinding of the natural zeolite, and includes natural zeolite heated ground product for which the fine powder component has been removed by classification post-grinding and natural zeolite heated ground product for which such classification has not been performed.

The natural zeolite ground product can be a natural zeolite ground product provided by grinding natural zeolite, either unheated or after heating, using a known grinding device, for example, a ball mill, vertical roller mill, and the like. The natural zeolite can also be heated during grinding by using a grinding device capable of implementing a heat treatment during grinding (for example, a grinding device that can admit a hot wind into the interior of the device). The execution of grinding with the addition of a grinding aid is preferred in order to increase the efficiency of grinding of the natural zeolite. Examples of the grinding aid include diethylene glycol, triethanolamine, triisopropanolamine, and the like. The proportion of addition of these grinding aids is preferably 0.01 to 1 mass part per 100 mass parts of the natural zeolite.

The Blaine specific surface area is an example of an index of the particle size. The “Blaine specific surface area” is the specific surface area measured by the Blaine method and is determined according to JIS A 6201:2015 and 8.1 of JIS R 5201, which is cited in 8.5.2 of JIS A 6201:2015. From the standpoint of improving the strength of concrete prepared with the addition of the cement additive, the Blaine specific surface area of the natural zeolite grinding product prior to classification is preferably 7,500 cm²/g or more and more preferably 9,000 cm²/g or more.

On the other hand, from the standpoint of improving the fluidity of concrete prepared with the addition of the cement additive, the Blaine specific surface area of the natural zeolite ground product prior to classification is preferably 15,000 cm²/g or less and more preferably 13,500 cm²/g or less.

The BET specific surface area is also an example of an index of the particle size. The “BET specific surface area” denotes the value obtained by applying the BET formula to an adsorption isotherm, obtained by nitrogen adsorption, measured on the target material. The BET specific surface area of the natural zeolite ground product prior to classification can be, for example, 80,000 to 300,000 cm²/g and is preferably 150,000 to 250,000 cm²/g.

The cumulative volume 50% diameter (D50) is another example of an index of the particle size. The “D50 (cumulative volume)” denotes the cumulative volume 50% particle diameter in the cumulative particle size distribution for the measurement target as obtained by laser diffraction/scattering. The D50 (cumulative volume) of the natural zeolite ground product prior to classification can be, for example, in the range from 3 μm to 15 μm.

The density of the natural zeolite ground product prior to classification can be in the range of, for example, 2.00 to 2.80 g/cm³ as the density determined according to JIS A 6201:2015 and section 7 of JIS R 5201, which is cited in 8.4 of JIS A 6201:2015.

However, the ranges for the Blaine specific surface area, BET specific surface area, D50, and density given in the preceding are examples and do not limit the present invention.

### (Classification)

A dry or wet classifier can be used for classification of the natural zeolite ground product. The natural zeolite ground product may also be heated during classification by using a classifier that can carry out heat treatment during classification (for example, a classifier that can admit a hot wind into the interior of the device).

For example, examples of dry classifiers include centrifugal air classifiers, airflow classifiers, and the like. “Classification” is a process that fractionates a powder according to particle size, and fractionation may be carried out into two classification fractions having different particle sizes (a coarse powder component and a fine powder component), or fractionation may be carried out into three classification fractions having different particle sizes (a coarse powder component, a middle powder component, and a fine powder component), or fractionation may be carried out into four or more classification components having different particle sizes. As has been described in the preceding, natural zeolites usually contain multiple types of minerals, and as a consequence the susceptibility to grinding differs depending on differences in the hardnesses of the individual minerals. The particle size distribution of the natural zeolite ground product will generally contain a plurality of peaks as a result. Classification points are preferably established in classification of the natural zeolite ground product so as to separate the plurality of peaks.

For example, in the curve showing the rate of change in the particle size distribution, a position where the rate of change is near zero can be made a classification point. Each component fractionated by the classification has a sharper particle size distribution than the ground product before classification. The n-value is an example of an index for a particle size distribution. The “n-value” is the exponent n in the Talbot curve P=(d/D)ⁿ×100 and is obtained as the slope of log d in a log-log plot of log (P/100) and log d. P is the accumulated pass rate, D is the maximum particle size, d is an arbitrary particle size, and n is the exponent. The meaning is that the larger the n-value, the sharper the particle size distribution. Each component afforded by classification of the natural zeolite ground product has an n-value that is larger than the n-value of the natural zeolite ground product prior to classification. The n-value of each component afforded by classification of the natural zeolite ground product can be, for example, in the range from 1.5 to 4.0 and preferably from 2.0 to 3.0, but is not limited to this range.

A grinder/classifier that can carry out grinding and classification may also be used to prepare and classify the ground product. Moreover, by using, as the grinder/classifier, a grinder/classifier that can carry out a heat treatment during grinding and/or during classification (for example, a grinder/classifier that can admit a hot wind into the interior of the device), the natural zeolite can also be heated during grinding and/or the natural zeolite ground product can also be heated during classification.

In the present invention and the present description, the “fine powder component” removed by classification refers, among the plurality of classification fractions fractionated by classification, to the classification fraction on the finest powder side. The entire classified material corresponding to the ground product yielded by removal of the classification fraction on the finest powder side may be used as a component of the cement additive, or a portion thereof may be used as a component of the cement additive. For example, after classifying and fractionating the ground product into two classification fractions having different particle sizes (coarse powder component and fine powder component), the entire coarse powder component may be used as a component of the cement additive, or a portion of the coarse powder component may be used as a component of the cement additive. When the ground product is classified and fractionated into three classification fractions having different particle sizes (coarse powder component, middle powder component, and fine powder component), a portion or all of the coarse powder component may be used as a component of the cement additive, or a portion or all of the middle powder component may be used as a component of the cement additive. In addition, a portion or all of the coarse powder component and a portion or all of the middle powder component may be mixed in any proportions and this may be used as a component of the cement additive. These considerations also apply when the ground product is classified and fractionated into four or more classification fractions having different particle sizes. In all embodiments, the cement additive does not contain the classification fraction on the finest powder side in the grinding product. The present inventors assume that this point is the reason why the fluidity reduction in cement composition can be suppressed by the cement additive that has been described in the preceding.

As an example, the Blaine specific surface area of the fine powder component may be 15,000 cm²/g or more, or 20,000 cm²/g or more, and the BET specific surface area of the fine powder component may be 140,000 cm²/g or more, or 160,000 cm²/g or more.

From the standpoint of improving the fluidity of concrete prepared with the addition of the cement additive, the classification point when removing the fine powder component is preferably 2.5 μm or more and is more preferably 5 μm or more. On the other hand, from the standpoint of improving the strength of concrete prepared with the addition of the cement additive, the classification point when removing the fine powder component is preferably 15 μm or less and more preferably 10 μm or less. The coarse powder component may be removed by classification in order to raise the strength of the concrete (for example, classification points of 15 μm and 10 μm). When the concrete has a low fluidity, the fluidity can be improved by raising the classification points.

However, the values given here are examples and do not limit the present invention.

From the standpoint of improving the strength of concrete prepared with the addition of the cement additive, the Blaine specific surface area of the natural zeolite ground product (i.e., the classified material of the natural zeolite ground product from which at least the fine powder component has been removed; this also applies herebelow) contained in the cement additive preferably is 2,000 cm²/g or more and is more preferably 2,300 cm²/g or more. On the other hand, from the standpoint of improving the fluidity of concrete prepared with the addition of the cement additive, the Blaine specific surface area of the natural zeolite ground product contained in the cement additive is preferably 9,000 cm²/g or less and is more preferably 8,000 cm²/g or less.

The BET specific surface area of the natural zeolite ground product contained in the cement additive is preferably in the range from 60,000 to 150,000 cm²/g and is more preferably in the range from 80,000 to 120,000 cm²/g.

The D50 (cumulative volume) of the natural zeolite ground product contained in the cement additive is preferably in the range from 4 to 30 μm and is more preferably in the range from 7 to 25 μm.

### <Heating of the Natural Zeolite>

In the cement additive manufacturing method 2, a heated ground product of natural zeolite is prepared by heating a natural zeolite at one or more of any of prior to grinding of the natural zeolite, during grinding of the natural zeolite, and after grinding of the natural zeolite.

In the cement additive manufacturing method 1, the ground product of natural zeolite can be heated at one or more of any of prior to classification, during classification, and after classification.

That is, heating of the natural zeolite can be executed on the natural zeolite in any one or more stages of pre-grinding, during grinding, and post-grinding, and can also be executed on the natural zeolite ground product prior to classification, on the natural zeolite ground product during classification, and on the ground product after the fine powder component has been removed by classification. Heating of the natural zeolite can be executed in only one stage of any of those described above, or may executed in any combination of two or more stages.

A known heating means, such as a heating furnace or a dryer, can be used for heating. Specific examples of heating furnaces include kilns and hot blast stoves. Examples of the heat source for the heating means include exhaust gas from a clinker cooler in a cement plant, exhaust gas from a cement kiln or a calcination oven, the combustion of various fuels, electricity, sunlight, electromagnetic waves, and the like. Heating can also be executed by introducing a heated gas into a grinder/classifier, grinder, or classifier capable of admitting a hot gas.

In the heating carried out in any of the stages described in the preceding, the temperature and time for heating the natural zeolite may be established as appropriate in accordance with the size of the natural zeolite, and heating is preferably carried out until a constant weight is achieved.

From the standpoint of the fluidity of the concrete, the heating temperature is preferably 200° C. or higher, more preferably 250° C. or higher, still more preferably 300° C. or higher, even more preferably 500° C. or higher, and particularly preferably 600° C. or higher. From this same standpoint, the heating temperature is preferably 900° C. or lower, more preferably 800° C. or lower, and still more preferably 700° C. or lower. In the present invention and the present description, the “heating temperature” can be, for example, the set temperature that is set at the heating means. In the case of a heating furnace in which the heating temperature history is not constant, the “heating temperature” can be the maximum temperature that is set.

From the standpoints of the fluidity and production costs of concrete, the heating time is preferably 15 minutes to 6 hours, more preferably 20 minutes to 3 hours, and still more preferably 30 minutes to 2 hours. It is preferable, from the standpoint of shortening the required time, to heat the natural zeolite ground product or the ground product after fine powder component removal.

When the fine powder component is removed by classification of the heated ground product of natural zeolite, the classification point when removing the fine powder component is preferably 2.5 μm or more and more preferably 5 μm or more from the standpoint of improving the fluidity of concrete prepared with the addition of the cement additive. On the other hand, from the standpoint of improving the strength of concrete prepared with the addition of the cement additive, the classification point when removing the fine powder component is preferably 15 μm or less and more preferably 10 μm or less. The coarse powder component may be removed by classification in order to raise the strength of the concrete (for example, classification points of 15 μm and 10 μm). When the concrete has a low fluidity, the fluidity can be improved by raising the classification points.

The n-value of the heated ground product of natural zeolite can be, for example, in the range from 1.3 to 4.0 and preferably in the range from 1.5 to 3.0, but is not limited to this range.

From the standpoint of improving the strength of concrete prepared with the addition of the cement additive, the Blaine specific surface area of the heated ground product of natural zeolite is preferably 2,000 cm²/g or more and more preferably 2,300 cm²/g or more. On the other hand, from the standpoint of improving the fluidity of concrete prepared with the addition of the cement additive, the Blaine specific surface area of the natural zeolite ground product contained in the cement additive is preferably 15,000 cm²/g or less and is more preferably 13,000 cm²/g or less.

The BET specific surface area of the heated ground product of natural zeolite contained in the cement additive is preferably in the range from 60,000 to 180,000 cm²/g and is more preferably in the range from 80,000 to 150,000 cm²/g. When the fine powder component is removed by classifying the heated ground product of natural zeolite, the BET specific surface area of the fine powder component may be 140,000 cm²/g or more or 160,000 cm²/g or more.

The D50 (cumulative volume) of the heated ground product of natural zeolite contained in the cement additive is preferably in the range from 4 to 30 μm and is more preferably in the range from 7 to 25 μm.

However, the values given here are examples and do not limit the present invention.

Cement additive manufactured by cement additive manufacturing method 1 contains at least classified material of the natural zeolite ground product from which at least the fine powder component has been removed. The classified material contained in the cement additive may have been heated as described above, or may not have been subjected to the heating described above.

The cement additive manufactured by cement additive manufacturing method 2 contains at least the heated ground product of natural zeolite. The heated ground product of natural zeolite contained in the cement additive may be the heated ground product from which the fine powder component has been removed by classification, or may not have been subjected to such a classification.

Alternatively, the cement additive can also be manufactured by combining cement additive manufacturing method 1 and cement additive manufacturing method 2. The cement additive thus manufactured can contain at least the above classified material and the heated ground product.

The cement additive may consist of only the above classified material and/or the heated ground product or may contain one or more additional components. In the production of a cement additive that contains the above classified material and/or the heated ground product and two or more additional components, the above classified material and/or the heated ground product and the two or more additional components can be mixed all at the same time or in any sequence. Using 100 mass parts for the total amount of the cement additive, the cement additive preferably contains 50 mass parts or more of the above classified material and/or the heated ground product and may even contain 100 mass parts thereof. Using 100 mass parts for the total amount of the cement additive, the content of the additional components (their total content when two or more additional components are incorporated) is preferably 50 mass parts or less and more preferably is in the range of 25 to 40 mass parts.

Examples of the additional components include pozzolanic powders such as volcanic ash, fly ash, and fired clay; mineral powders such as limestone, silica, and steelmaking slag; and powders of latent hydraulic materials such as blast furnace slag.

For example, for fly ash, the Blaine specific surface area is preferably in the range of 3,000 to 10,000 cm²/g and is more preferably in the range of 4,000 to 8,000 cm²/g. For limestone powder, it is preferably in the range of 3,000 to 10,000 cm²/g, and is more preferably in the range of 4,500 to 8,000 cm²/g. For blast furnace slag powder, it is preferably in the range of 3,000 to 10,000 cm²/g and is more preferably in the range of 4,000 to 8,000 cm²/g.

The cement additive may also contain, as an additional component, one or more components selected from the group consisting of gypsum powders, for example, gypsum dihydrate, flue gas desulfurization gypsum, phosphogypsum, titanium gypsum, fluorogypsum, refined gypsum, gypsum hemihydrate, and anhydrous gypsum. The amount of addition thereof (their total content when a plurality of components are incorporated), using 100 mass parts for the total amount of the cement additive, is preferably, as SO₃ conversion, 5 mass parts or less and more preferably in the range of 1 to 3 mass parts.

In an embodiment, the cement additive can contain one or both of fly ash and limestone powder.

In an embodiment, the above additional component can be incorporated as a constituent component of the cement additive, while, in another embodiment, the additional component can be employed by mixing with the cement additive during the production of a cement composition. For the amount of admixture of the additional component in the latter embodiment, reference can be made to the previous description in relation to the content in the cement additive.

The cement additives yielded by the manufacturing method described in the preceding can be used to manufacture the cement composition.

### [Method of Manufacturing Cement Composition]

An aspect of the present invention relates to a method of manufacturing a cement composition. The method of manufacturing a cement composition includes: preparing a cement additive by a cement additive manufacturing method that has been described in the preceding; and mixing the manufactured cement additive with at least a ground cement clinker. Production of a cement composition by the manufacturing method makes it possible to provide—notwithstanding the incorporation of natural zeolite—a cement composition for which fluidity reductions are suppressed.

The cement composition manufacturing method is described in greater detail in the following.

In the present invention and the present description, the “cement composition” includes cement and concrete. “Concrete” includes mortar, concrete, and cement paste.

The above cement additive can be, for example, a component that replaces all or a portion of a cement additive conventionally used in cement compositions. Examples of the cement additive conventionally used include fly ash.

When cement is manufactured as the cement composition, the above cement additive can be used as a cement admixture. The essential component to be mixed with the cement admixture is ground cement clinker, while additional optional components can be, for example, gypsum powder, limestone powder, and the like. The type of cement clinker is not particularly limited and can be exemplified by Portland cement clinker, for example, ordinary Portland cement clinker, high-early-strength Portland cement clinker, moderate heat Portland cement clinker, low heat Portland cement clinker, and the like, and eco-cement clinker and the like. Among these, ordinary Portland cement clinker, which is highly versatile, is preferred. The types of gypsum is also not particularly limited and examples of gypsum include gypsum dihydrate, gypsum hemihydrate, anhydrous gypsum, and the like. Ground gypsum can be used as the gypsum powder. For example, the cement additive can be added to Portland cement, for example, ordinary Portland cement, high-early-strength Portland cement, moderate heat Portland cement, low heat Portland cement, and the like, or eco-cement and the like, in which ground cement clinker has been mixed with gypsum powder. Limestone powder can also be added simultaneously with or separately from the addition of the cement additive.

When concrete is manufactured as the cement composition, in an embodiment, cement containing the cement additive can be used to manufacture the concrete. More particularly, the concrete can be manufactured by mixing cement containing the cement additive with components for concrete production, for example, aggregate, water, water-reducing agent, gypsum powder, limestone powder, and the like, or concrete can be manufactured by also additionally mixing with cement that does not contain the cement additive.

In addition, when concrete is manufactured as the cement composition, in an embodiment, the cement additive can be used as a concrete admixture. Additional components for mixing with the concrete admixture can be exemplified by aggregate, cement (containing at least ground cement clinker), water, water-reducing agent, gypsum powder, limestone powder, and the like. That is, in an embodiment, the cement additive is mixed, at the time of cement production, with ground cement clinker of the form incorporated in cement.

The water content in the cement is preferably in the range of 30 to 70 mass parts using 100 mass parts for the total amount of cement excluding aggregate and water.

The following can be used for the water-reducing agent: water-reducing agents such as lignin-based water-reducing agents, naphthalenesulfonic acid-based water-reducing agents, melamine-based water-reducing agents, polycarboxylic acid-based water-reducing agents, and the like, and AE water-reducing agents, high-performance water-reducing agents, and high-performance AE water-reducing agents. The water-reducing agent content in the cement, using 100 mass parts for the total amount of the cement excluding the aggregate and water, is preferably 4 mass parts or less, more preferably in the range from 0.5 to 3.5 mass parts, and even more preferably in the range from 1 to 3 mass parts.

The fine aggregate (for example, river sand, terrestrial sand, crushed sand, and the like) and/or coarse aggregate (for example, river gravel, mountain gravel, crushed stone, and the like) that are normally used in the production of mortar and concrete can be used as the aggregate. In addition, waste materials, for example, molten slags (for example, manufactured by melting one or more components selected from urban waste, urban waste incineration ash, and sewage sludge incineration ash), blast furnace slags, steelmaking slags, copper slags, insulator scraps, glass cullet, ceramic waste, clinker ash, waste bricks, and concrete waste, can also be used as all or a portion of the aggregate.

Admixtures such as air-entraining agents, antifoaming agents, and the like may also be used as necessary.

Using 100 mass % for the total mass of the cement composition (but excluding the masses of the aggregate, ground cement clinker, and gypsum powder when these are incorporated), the content of the cement additive in the cement composition manufactured by the manufacturing method described in the preceding can be, for example, 5 mass % or more or 10 mass % or more from the standpoints of the initial strength of the cement composition and reductions in CO₂, and can be, for example, 50 mass % or less, 40 mass % or less, 30 mass % or less, or 20 mass % or less from the standpoint of long-term strength.

### EXAMPLES

The present invention is further described in the following based on Examples. However, the present invention is not limited to or by the embodiments shown in Examples.

### [Natural Zeolite Ground Product Z1]

Natural zeolite ground product Z1 was obtained by grinding a natural zeolite (zeolite rocks) with a ball mill.

### [Coarse Powder Component Zc, Middle Powder Component Zm, Fine Powder Component Zf]

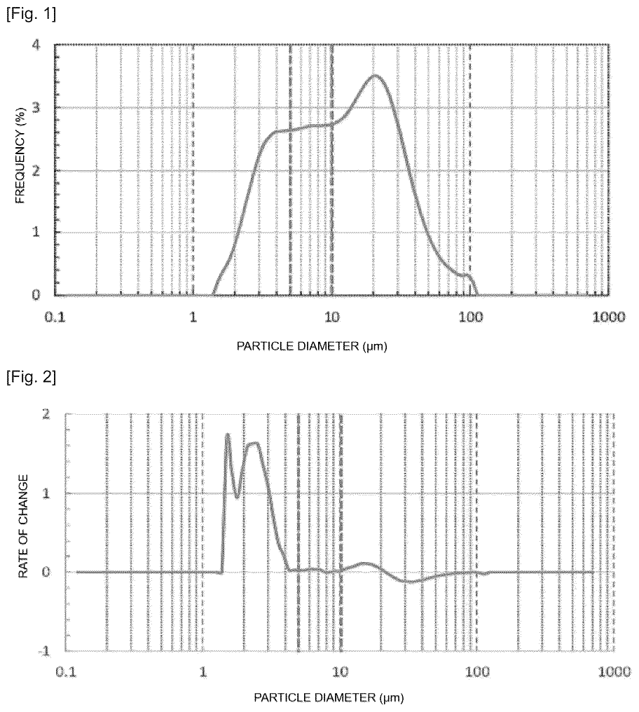

A portion of the natural zeolite ground product Z1 was sampled and its particle size distribution was measured using a laser diffraction/scattering particle size distribution analyzer (MT3300 EX II, MicrotracBEL Corp.). The measurement results are given in FIG. 1. It can be confirmed from FIG. 1 that the particle size distribution of the natural zeolite ground product Z1 has multiple peaks.

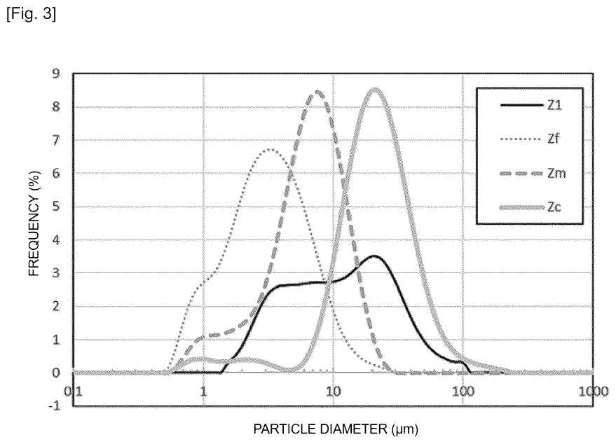

FIG. 2 is a graph that shows the rate of change in the particle size distribution given in FIG. 1. In order to separate the multiple peaks of the particle size distribution of the natural zeolite ground product Z1, classification points were set at the positions where the rate of change in the particle size distribution given in FIG. 2 was near zero (particle diameters of 5 μm and 10 μm) and the natural zeolite ground product Z1 was classified using a centrifugal air classifier (O-SEPA, Taiheiyo Engineering Corporation) and was separated into three classification fractions (coarse powder component Zc (classification point: from 10 μm), middle powder component Zm (classification points: 5 to 10 μm), and fine powder component Zf (classification point: to 5 μm)). Samples from these three classification fractions yielded by the classification of the natural zeolite ground product Z1 were acquired and submitted to measurement of the particle size distribution using a laser diffraction/scattering particle size distribution analyzer (MT3300 EX II, MicrotracBEL Corp.). The measurement results are given in FIG. 3. It can be confirmed from the results given in FIG. 3 that the multiple peaks in the particle size distribution of the natural zeolite ground product Z1 can be separated by this classification.

Using the previously described method, the n-value was determined from these particle size distribution measurement results for the natural zeolite ground product Z1, the coarse powder component Zc, the middle powder component Zm, and the fine powder component Zf.

The results are reported in Table 1. As shown in Table 1, the n-values for the coarse powder component Zc, the middle powder component Zm, and the fine powder component Zf are larger than the n-value of the natural zeolite ground product Z1 prior to classification. It can be confirmed based on these results that the particle size distributions of the coarse powder component Zc, the middle powder component Zm, and the fine powder component Zf are sharper than that of the natural zeolite ground product Z1 prior to classification.

### [Physical Property Measurements]

The following were measured using the previously described methods on each of the components listed in Table 1: density, Blaine specific surface area, and BET specific surface area. The “ordinary Portland cement” in Table 1 is more particularly a ground ordinary Portland cement clinker. The BET specific surface area was measured using an automatic flow-type specific surface area analyzer (FlowSorb 2305, Shimadzu Corporation). The measurement results are given in Table 1.

TABLE 1

| | | | Blaine | BET | |
|---|---|---|---|---|---|
| | | | specific | specific | |
| | | | surface | surface | |
| | | Density | area | area | |
| Sample | Designation | (g/cm³) | (cm²/g) | (cm²/g) | n-value |
| Ordinary Portland cement | OPC | 3.15 | 3120 | — | — |
| Natural zeolite ground product | Z1 | 2.47 | 12400 | 151300 | 1.43 |
| Classified zeolite (fine powder component) | Zf | 2.46 | 21760 | 171000 | 3.51 |
| Classified zeolite (middle powder component) | Zm | 2.47 | 8100 | 119700 | 2.82 |
| Classified zeolite (coarse powder component) | Zc | 2.49 | 2480 | 90300 | 2.10 |
| Fly ash | FA | 2.36 | 4380 | 10800 | — |
| Limestone fine powder | LSP | 2.75 | 5320 | 14200 | — |
| Blast furnace slag fine powder | BFS | 2.87 | 4700 | 13000 | — |

### [Compositional Analysis]

The mineral composition and zeolite purity of each of the natural zeolite ground product Z1, the coarse powder component Zc, the middle powder component Zm, and the fine powder component Zf were determined by X-ray diffraction analysis. The X-ray diffraction analysis was carried out using a Bruker D8 ADVANCE as the X-ray diffractometer, and the content of each mineral phase was determined by fitting the theoretical profile of each mineral shown in Table 2 to the measured profile using the Rietveld method. The results are given in Table 2. In Table 2, the “-Ca” in “clinoptilolite-Ca” indicates the calcium salt. The “%” in the mineral composition is on a mass basis. For the zeolite purity, the “zeolite purity” was taken to be the total of the contents of clinoptilolite-Ca, mordenite, and amorphous. These points also apply for the Table 4 given below.

TABLE 2

| | | Mineral composition (%) | | | | | | | |
|---|---|---|---|---|---|---|---|---|---|
| | Desig- | | | Clinoptilolite- | | | | | Zeolite |
| Sample | nation | Anorthite | Cristobalite | Ca | Quartz | Biotite | Mordenite | Amorphous | purity (%) |
| Natural zeolite | Z1 | 11.5 | 5.4 | 16.1 | 11.0 | 4.5 | 3.6 | 48.0 | 67.7 |
| ground product | | | | | | | | | |
| Classified zeolite | Zf | 9.6 | 6.1 | 19.6 | 15.0 | 3.8 | 3.5 | 42.3 | 65.5 |
| (fine powder | | | | | | | | | |
| component) | | | | | | | | | |
| Classified zeolite | Zm | 10.6 | 6.0 | 17.7 | 11.5 | 3.5 | 3.5 | 47.2 | 68.3 |
| (middle powder | | | | | | | | | |
| component) | | | | | | | | | |
| Classified zeolite | Zc | 12.2 | 5.4 | 16.1 | 10.5 | 2.3 | 3.2 | 50.2 | 69.5 |
| (coarse powder | | | | | | | | | |
| component) | | | | | | | | | |

### [Natural Zeolite Heated Ground Product Z1-2]

A portion (500 g) of the natural zeolite ground product Z1 was collected and was heated using the following method.

Heating was carried out by placing a heat-resistant container containing the natural zeolite ground product Z1 in a box-type electric furnace (S7-2035D-OP, Motoyama Co., Ltd.) set at a set temperature of 200° C. The heat-resistant container was removed from the electric furnace every hour and the mass was measured, and heating was performed until a constant mass was reached.

### [Natural Zeolite Heated Ground Product Z1-3]

Natural zeolite heated ground product Z1-3 was prepared using the method described above for natural zeolite heated ground product Z1-2, with the exception that 300° C. was used for the set temperature on the electric furnace.

### [Natural Zeolite Heated Ground Product Z1-5]

Natural zeolite heated ground product Z1-5 was prepared using the method described above for natural zeolite heated ground product Z1-2, with the exception that 500° C. was used for the set temperature on the electric furnace.

### [Natural Zeolite Heated Ground Product Z1-8]

Natural zeolite heated ground product Z1-8 was prepared using the method described above for natural zeolite heated ground product Z1-2, with the exception that 800° C. was used for the set temperature on the electric furnace.

### [Natural Zeolite Heated Ground Product Z1-10]

Natural zeolite heated ground product Z1-10 was prepared using the method described above for natural zeolite heated ground product Z1-2, with the exception that 1,000° C. was used for the set temperature on the electric furnace.

### [Natural Zeolite Heated Ground Product Zm-3 (Heated Middle Powder Component Zm)]

A portion (500 g) of the middle powder component Zm was collected, and natural zeolite heated ground product Zm-3 (heated middle powder component Zm) was prepared using the method described above for natural zeolite heated ground product Z1-2, with the exception that 300° C. was used for the set temperature on the electric furnace.

A constant mass was reached after heating for 1 hour or 2 hours in the preparation of all of these natural zeolite heated ground products.

### [Physical Property Measurement]

The following were measured using the previously described methods for each of the components listed in Table 3: density, Blaine specific surface area, BET specific surface area, and n-value. The BET specific surface area was measured using an automatic flow-type specific surface area analyzer (FlowSorb 2305, Shimadzu Corporation). The measurement results are given in Table 3. Due to the occurrence of melting of the natural zeolite heated ground product Z1-10 (heating temperature: 1,000° C.), the Blaine specific surface area, BET specific surface area, and n-value could not be measured, and “-” is entered in the corresponding columns.

TABLE 3

| | | Density | Blaine specific surface area | BET specific surface area | |
|---|---|---|---|---|---|
| Sample | Designation | (g/cm³) | (cm²/g) | (cm²/g) | n-value |
| Natural zeolite heated ground product | Z1-2 | 2.49 | 12200 | 146000 | 1.42 |
| (Heating temperature: 200° C.) | | | | | |
| Natural zeolite heated ground product | Z1-3 | 2.51 | 12190 | 143000 | 1.51 |
| (Heating temperature: 300° C.) | | | | | |
| Natural zeolite heated ground product | Z1-5 | 2.54 | 12160 | 141000 | 1.62 |
| (Heating temperature: 500° C.) | | | | | |
| Natural zeolite heated ground product | Z1-8 | 2.54 | 11690 | 126700 | 2.48 |
| (Heating temperature: 800° C.) | | | | | |
| Natural zeolite heated ground product | Z1-10 | 2.57 | — | — | — |
| (Heating temperature: 1,000° C.) | | | | | |
| Natural zeolite heated ground product | Zm-3 | 2.55 | 8030 | 115400 | 2.88 |
| (Heated middle powder component Zm, | | | | | |
| heating temperature: 300° C.) | | | | | |

### [Compositional Analysis]

Using the previously described methods, the mineral composition and zeolite purity were determined for each of the components given in Table 4. The results are given in Table 4. Due to the occurrence of melting with the natural zeolite heated ground product Z1-10 (heating temperature: 1,000° C.), the mineral composition was not measured.

TABLE 4

| | | Mineral composition (%) | | | | | | | |
|---|---|---|---|---|---|---|---|---|---|
| | Desig- | | | Clinoptilolite- | | | | | Zeolite |
| Sample | nation | Anorthite | Cristobalite | Ca | Quartz | Biotite | Mordenite | Amorphous | purity (%) |
| Natural zeolite heated | Z1-2 | 11.8 | 5.5 | 16.5 | 11.8 | 4.4 | 3.8 | 46.2 | 66.5 |
| ground product | | | | | | | | | |
| (Heating temperature: | | | | | | | | | |
| 200° C.) | | | | | | | | | |
| Natural zeolite heated | Z1-3 | 12.0 | 5.4 | 15.3 | 11.7 | 4.2 | 3.6 | 47.8 | 66.7 |
| ground product | | | | | | | | | |
| (Heating temperature: | | | | | | | | | |
| 300° C.) | | | | | | | | | |
| Natural zeolite heated | Z1-5 | 12.1 | 5.4 | 16.2 | 11.5 | 4.6 | 3.4 | 46.8 | 66.4 |
| ground product | | | | | | | | | |
| (Heating temperature: | | | | | | | | | |
| 500° C.) | | | | | | | | | |
| Natural zeolite heated | Z1-8 | 12.2 | 5.8 | 11.5 | 11.8 | 3.0 | 3.7 | 52.0 | 67.2 |
| ground product | | | | | | | | | |
| (Heating temperature: | | | | | | | | | |
| 800° C.) | | | | | | | | | |
| Natural zeolite heated | Zm-3 | 11.0 | 5.7 | 16.2 | 11.7 | 3.5 | 3.7 | 48.2 | 68.1 |
| ground product | | | | | | | | | |
| (Heated middle powder | | | | | | | | | |
| component Zm, | | | | | | | | | |
| heating temperature: | | | | | | | | | |
| 300° C.) | | | | | | | | | |

### Examples 1 to 26, Comparative Examples 1 to 3, Reference Examples 1 to 4

### (1) Mortar Preparation

Using the cement compositions of the blends shown in Table 5, mortars were blended and mixed according to the description of mortar for strength testing in JIS R5201:2015. The blending ratios shown in Table 5 are mass ratios for the powder excluding the aggregate. Gypsum powder is incorporated at 2 mass % as SO₃ conversion relative only to the OPC. However, an air amount adjuster was added at 0.04 mass % relative to 100 mass % for the total powder amount ((B) in Table 5), and a polycarboxylic acid-based high-performance water-reducing agent (SP agent: Super Plasticizer) was added such that the 15-stroke flow in the flow test performed according to JIS R5201:2015 was 230 mm±20 mm. The amount of SP agent added at this time was the value shown in Table 5 relative to 100 mass % for the total powder amount. The 0-stroke flow of the mortar thus prepared in the flow test performed according to JIS R5201:2015 was the value shown in Table 5. With regard to the amount of SP agent addition, the standard amount of addition recommended by the manufacturer for the SP agent used is 3.0 mass % or less. Therefore, when the amount of SP agent addition shown in Table 5 is 3.0 mass % or less, the fluidity can be regarded as being controlled at within the ordinary range for the amount of addition.

### (2) Measurement of the Amount of Air

Using the mortar with a fluidity adjusted by the addition of SP agent according to (1) above, the amount of air was measured using a mortar air meter in accordance with JIS A1171:2016. The amount of air is preferably 2.0% or less.

### (3) Measurement of the Compressive Strength

Using the mortar with a fluidity adjusted by the addition of SP agent according to (1) above, a cylindrical specimen of diameter 5 cm×length 10 cm was molded in accordance with JSCE-G 505-2010 and the compressive strength was measured at material ages of 3 days, 7 days, 28 days, and 91 days.

These results are given in Table 5.

TABLE 5

| | | | | | | | | | | | | | | Performance evaluation | | | | | | | |
|---|---|---|---|---|---|---|---|---|---|---|---|---|---|---|---|---|---|---|---|---|---|
| | | | | | | | | | | | | | | Amount | | | | | | | |
| | | | | | | | | | | | | | | of SP | Flow, | | | Compressive | | | |
| | Material composition (mass %) of cement mixture | | | | | | | | | | | | | agent | mm | | Amount | strength, MPa | | | |
| | | | | | | | | | Z1- | Z1- | Z1- | Z1- | Zm- | addition | 0- | 15- | of air | 3 | 7 | 28 | 91 |
| | OPC | Z1 | Zf | Zm | Zc | FA | LSP | BFS | 2 | 3 | 5 | 8 | 3 | mass % | stroke | strokes | vol. % | days | days | days | days |
| Comp. | 75 | 25 | | | | | | | | | | | | 3.1 | 152 | 217 | 2.5 | 11.7 | 26.2 | 47.7 | 57.9 |
| Ex. 1 | | | | | | | | | | | | | | | | | | | | | |
| Comp. | 70 | 30 | | | | | | | | | | | | 3.8 | 127 | 210 | 2.7 | 11.3 | 23.8 | 44.0 | 53.6 |
| Ex. 2 | | | | | | | | | | | | | | | | | | | | | |
| Comp. | 80 | | 20 | | | | | | | | | | | 3.6 | 160 | 218 | 2.1 | 16.0 | 32.6 | 54.5 | 64.4 |
| Ex. 3 | | | | | | | | | | | | | | | | | | | | | |
| Ex. 1 | 90 | | | 10 | | | | | | | | | | 1.2 | 170 | 215 | 1.8 | 22.0 | 37.3 | 54.5 | 62.9 |
| Ex. 2 | 85 | | | 15 | | | | | | | | | | 2.0 | 165 | 232 | 1.3 | 17.5 | 34.5 | 55.6 | 66.1 |
| Ex. 3 | 80 | | | 20 | | | | | | | | | | 2.6 | 175 | 222 | 1.5 | 15.7 | 32.4 | 52.4 | 61.5 |
| Ex. 4 | 90 | | | | 10 | | | | | | | | | 0.7 | 164 | 232 | 1.7 | 20.6 | 34.9 | 51.6 | 60.8 |
| Ex. 5 | 85 | | | | 15 | | | | | | | | | 1.4 | 167 | 236 | 1.7 | 16.8 | 32.1 | 51.3 | 61.2 |
| Ex. 6 | 80 | | | | 20 | | | | | | | | | 2.1 | 162 | 228 | 1.4 | 14.2 | 30.1 | 47.6 | 58.5 |
| Ex. 7 | 75 | | | | 25 | | | | | | | | | 2.7 | 163 | 235 | 1.6 | 11.7 | 25.0 | 42.4 | 53.1 |
| Ex. 8 | 70 | | | | 30 | | | | | | | | | 3.0 | 169 | 242 | 1.8 | 11.1 | 22.8 | 39.4 | 51.0 |
| Ex. 9 | 75 | | | | 15 | 10 | | | | | | | | 2.4 | 177 | 240 | 1.0 | 15.0 | 28.5 | 45.4 | 57.2 |
| Ex. 10 | 75 | | | | 15 | | 10 | | | | | | | 2.4 | 159 | 223 | 1.2 | 17.5 | 32.3 | 48.0 | 56.9 |
| Ex. 11 | 75 | | | | 15 | | | 10 | | | | | | 2.8 | 157 | 228 | 1.4 | 16.3 | 28.3 | 50.5 | 62.6 |
| Ref. | 85 | | | | | 15 | | | | | | | | 0.4 | 155 | 239 | 1.7 | 20.4 | 34.4 | 49.2 | 63.1 |
| Ex. 1 | | | | | | | | | | | | | | | | | | | | | |
| Ref. | 80 | | | | | 20 | | | | | | | | 0.3 | 144 | 228 | 2.0 | 18.3 | 32.0 | 45.3 | 59.8 |
| Ex. 2 | | | | | | | | | | | | | | | | | | | | | |
| Ref. | 75 | | | | | 25 | | | | | | | | 0.3 | 150 | 233 | 1.5 | 16.7 | 29.2 | 42.8 | 56.6 |
| Ex. 3 | | | | | | | | | | | | | | | | | | | | | |
| Ref. | 70 | | | | | 30 | | | | | | | | 0.1 | 135 | 224 | 1.8 | 12.5 | 24.0 | 35.6 | 52.3 |
| Ex. 4 | | | | | | | | | | | | | | | | | | | | | |
| Ex. 12 | 85 | | | | | | | | 15 | | | | | 2.0 | 160 | 232 | 1.9 | 16.9 | 31.8 | 50.8 | 63.6 |
| Ex. 13 | 80 | | | | | | | | 20 | | | | | 2.4 | 180 | 235 | 1.7 | 14.5 | 28.6 | 47.2 | 60.3 |
| Ex. 14 | 75 | | | | | | | | 25 | | | | | 2.7 | 176 | 240 | 1.9 | 11.2 | 23.9 | 42.5 | 54.5 |
| Ex. 15 | 85 | | | | | | | | | 15 | | | | 1.9 | 158 | 218 | 1.7 | 16.5 | 32.5 | 52.0 | 60.4 |
| Ex. 16 | 80 | | | | | | | | | 20 | | | | 2.4 | 154 | 225 | 1.5 | 13.7 | 30.5 | 47.3 | 57.2 |
| Ex. 17 | 75 | | | | | | | | | 25 | | | | 2.6 | 160 | 218 | 1.6 | 11.4 | 25.6 | 43.3 | 51.1 |
| Ex. 18 | 85 | | | | | | | | | | 15 | | | 1.8 | 170 | 215 | 1.8 | 17.5 | 32.0 | 52.4 | 62.9 |
| Ex. 19 | 80 | | | | | | | | | | 20 | | | 2.2 | 165 | 232 | 1.3 | 14.5 | 28.9 | 48.2 | 59.9 |
| Ex. 20 | 75 | | | | | | | | | | 25 | | | 2.5 | 175 | 222 | 1.5 | 12.0 | 24.4 | 43.9 | 52.0 |
| Ex. 21 | 85 | | | | | | | | | | | 15 | | 1.1 | 155 | 218 | 1.7 | 19.4 | 33.2 | 53.1 | 60.7 |
| Ex. 22 | 80 | | | | | | | | | | | 20 | | 1.2 | 158 | 220 | 1.6 | 17.0 | 29.5 | 49.8 | 59.8 |
| Ex. 23 | 75 | | | | | | | | | | | 25 | | 1.6 | 164 | 232 | 1.7 | 13.2 | 25.5 | 46.0 | 54.6 |
| Ex. 24 | 85 | | | | | | | | | | | | 15 | 1.5 | 168 | 230 | 1.6 | 16.3 | 31.1 | 51.3 | 60.0 |
| Ex. 25 | 80 | | | | | | | | | | | | 20 | 1.9 | 180 | 225 | 1.4 | 13.1 | 30.0 | 46.9 | 56.8 |
| Ex. 26 | 75 | | | | | | | | | | | | 25 | 2.1 | 178 | 233 | 1.7 | 11.3 | 24.9 | 42.5 | 50.7 |

The following points can be confirmed from the results given in Table 5. (1) Examples 1 to 11 are examples that used the middle powder component Zm or coarse powder component Zc of the natural zeolite ground product Z1 as a cement additive. The amount of SP agent addition exceeded 3.0 mass % in Comparative Examples 1 and 2, which used the natural zeolite Z1 as a cement additive, and in Comparative Example 3, which used the fine powder component Zf of the natural zeolite ground product Z1, while, in contrast to this, the amount of SP agent addition was 3.0 mass % or less in Examples 1 to 11. This result shows that the fluidity reduction of natural zeolite-containing cement compositions can be suppressed by removing the fine powder component Zf of the natural zeolite ground product Z1.

(2) Examples 12 to 26 are examples that used natural zeolite heated ground product Z1-2, Z1-3, Z1-5, or Z1-8 or natural zeolite heated ground product Zm-3 (heated middle powder component Zm) as a cement additive. As previously noted, the amount of SP agent addition in Comparative Examples 1 to 3 exceeded 3.0 mass %, while, in contrast to this, the amount of SP agent addition in Examples 12 to 26 was 3.0 mass % or less. This result shows that the fluidity reduction of natural zeolite-containing cement compositions can be suppressed by a natural zeolite heated ground product.

(3) The various performance indicators for Examples 1 to 26 were about the same as for Reference Examples 1 to 4, which contained fly ash. This result shows that the cement additive of Examples 1 to 26 can be used as a substitute for fly ash.

An aspect of the present invention is useful in fields where, for example, cement, concrete, and the like, are manufactured.

1. A method of manufacturing a cement additive, comprising:
removing a fine powder component by classifying a ground product of natural zeolite, wherein
the cement additive at least comprises at least a portion of the ground product after the removal of the fine powder component.

2. The manufacturing method according to claim 1, further comprising heating the ground product of natural zeolite at one or more of any of prior to the classification, during the classification, and after the classification.

3. The manufacturing method according to claim 2, wherein the heating temperature during the heating is 200° C. or higher and 900° C. or lower.

4. The cement additive manufacturing method according to claim 1, wherein the cement additive further comprises fly ash and/or limestone powder.

5. A method of manufacturing a cement additive, comprising:
preparing a heated ground product of natural zeolite by heating a natural zeolite at one or more of any of prior to natural zeolite grinding, during natural zeolite grinding, and after natural zeolite grinding, wherein
the cement additive at least comprises at least a portion of the heated ground product.

6. The manufacturing method according to claim 5, wherein the heating temperature during the heating is 200° C. or higher and 900° C. or lower.

7. A method of manufacturing a cement composition, comprising:
manufacturing a cement additive by the cement additive manufacturing method according to claim 1; and
mixing the manufactured cement additive with at least a ground cement clinker.

8. A method of manufacturing a cement composition, comprising:
manufacturing a cement additive by the cement additive manufacturing method according to claim 5; and
mixing the manufactured cement additive with at least a ground cement clinker.
